(19) United States
(12) Patent Application Publication
(10) Pub. No.: US 2017/0294151 A1
(43) Pub. Date: Oct. 12, 2017

(54) DEVICE FOR PREVENTING DEFORMATION OF DISPLAY DEVICE, DEFORMATION PREVENTION METHOD, AND DEFORMATION PREVENTION PROGRAM

(71) Applicant: NEC Corporation, Tokyo (JP)

(72) Inventor: Yoshikazu ARAI, Tokyo (JP)

(21) Appl. No.: 15/511,824

(22) PCT Filed: Sep. 16, 2015
(86) PCT No.: PCT/JP2015/076274

§ 371 Date: Mar. 16, 2017

(30) Foreign Application Priority Data
Sep. 19, 2014 (JP) 2014-191433

(51) Int. Cl. G09F 9/30

(52) U.S. Cl. CPC G09F 9/30

(57) ABSTRACT

A deformation preventing device for a display device includes: an elastically deformable sheet-shaped display unit; a sensor that integrally deforms with the display unit, and outputs a signal corresponding to deformation of the display unit; a control unit that compares an amount of the deformation of the display unit with a prescribed value based on the signal, and outputs a comparison result; and a drive unit that outputs a drive signal to an actuating unit based on the comparison result, the drive signal causing the actuating unit to perform a warning operation, the actuating unit being different from the display unit.

### TECHNICAL FIELD

The present invention relates to a deformation preventing device that can give a warning when a force has acted that attempts to bend a sheet-shaped display device, and to a deformation prevention method and a deformation prevention program.

### BACKGROUND ART

Elastically deformable flexible display devices are widely being used. These display devices are configured from plastic organic EL displays and the like, and are being used in many applications as electronic paper and various electronic operation devices.

For example, the information display device disclosed in Patent Document 1 has the constituent elements of a display input unit, an image display unit, and a display control unit. This information display device, on the basis of data input from the display input unit, executes a process to advance software steps, a process to scroll display content, and a process to enlarge and reduce display content.

### PRIOR ART DOCUMENTS

### Patent Document

[Patent Document 1] Japanese Unexamined Patent Application, First Publication No. 2014-67291

### SUMMARY OF INVENTION

### Problem to be Solved by the Invention

In the display device disclosed in Patent Document 1, when a bending force is imparted to the display input unit, in order to warn the user of that situation, the backlight is made to flash or turn off. Alternatively, in the display screen a warning dialog is displayed or a specific pattern is displayed or flashed.

However, due to the application of bending pressure in the state of the display device being placed, for example, in a bag, it is possible that a force exceeding the bending limit may be applied to the display device in a state where the user is not viewing the display screen. In such a case, in the display device disclosed in Patent Document 1, there is a risk of the display unit being broken.

The present invention has been achieved in view of the above circumstances. An exemplary object of the present invention is to provide a deformation preventing device that, when a force has acted that tries to bend a sheet-shaped display device, can prevent breakage of the device even when the user is not viewing the screen, a deformation prevention method, and a deformation prevention program.

### Means for Solving the Problem

In order to solve the aforementioned problem, the following means are proposed.

A deformation preventing device for a display device according to an exemplary aspect of the present invention includes: an elastically deformable sheet-shaped display unit; a sensor that integrally deforms with the display unit, and outputs a signal corresponding to deformation of the display unit; a control unit that compares an amount of the deformation of the display unit with a prescribed value based on the signal, and outputs a comparison result; and a drive unit that outputs a drive signal to an actuating unit based on the comparison result, the drive signal causing the actuating unit to perform a warning operation, the actuating unit being different from the display unit.

A deformation prevention method for a display device according to an exemplary aspect of the present invention includes: outputting, by a sensor that integrally deforms with an elastically deformable sheet-shaped display unit, a signal corresponding to deformation of the display unit; comparing an amount of the deformation of the display unit with a prescribed value of the display unit based on the basis of the signal, and outputting a comparison result; and outputting a drive signal to an actuating unit based on the comparison result, the drive signal causing the actuating unit to perform a warning operation, the actuating unit being different from the display unit.

A deformation prevention program for a display device according to an exemplary aspect of the present invention causes the display device to execute: outputting, by a sensor that integrally deforms with an elastically deformable sheet-shaped display unit, a signal corresponding to deformation of the display unit; comparing an amount of the deformation of the display unit with a prescribed value of the display unit based on the basis of the signal, and outputting a comparison result; and outputting a drive signal to an actuating unit based on the comparison result, the drive signal causing the actuating unit to perform a warning operation, the actuating unit being different from the display unit.

### Effect of the Invention

According to an exemplary embodiment of the present invention, even in the case of the user not viewing the display screen, it is possible to prevent breakage of a device.

### BRIEF DESCRIPTION OF THE DRAWINGS

FIG. 1 is an outline block diagram showing the constitution of a deformation preventing device for a display device according to an exemplary embodiment of the present invention.

FIG. 2 is an outline block diagram showing a display device according to a first exemplary embodiment.

FIG. 3A is a diagram showing the state of the display device shown in FIG. 2 being bent, being a schematic diagram showing the case of the left and right end portions being folded.

FIG. 3B is a diagram showing the state of the display device shown in FIG. 2 being bent, being a schematic diagram showing the case of the top and bottom end portions being folded.

FIG. 3C is a diagram showing the state of the display device shown in FIG. 2 being bent, being a schematic diagram showing the case of the display device folded in a wave shape.

FIG. 4 is a flowchart showing a deformation prevention program, which is a control content of a control unit in the first exemplary embodiment.

FIG. 5A is an outline block diagram showing a vibrator for warning, as a modification of an actuating unit in the first exemplary embodiment.

FIG. 5B is an outline block diagram showing a warning LED, as a modification of the actuating unit in the first exemplary embodiment.

FIG. 5C is an outline block diagram showing a communication unit for warning to the outside, as a modification of the actuating unit in the first exemplary embodiment.

FIG. 6 is an outline block diagram showing a display device according to a second exemplary embodiment.

FIG. 7A is a schematic diagram showing an arrangement pattern of shape memory materials in the second exemplary embodiment.

FIG. 7B is a schematic diagram showing another arrangement pattern of the shape memory materials in the second exemplary embodiment.

FIG. 7C is a schematic diagram showing yet another arrangement pattern of the shape memory materials in the second exemplary embodiment.

FIG. 8 is a schematic diagram showing a backbone member in the first and second exemplary embodiments.

FIG. 9A is a schematic diagram showing an arrangement pattern of the backbone member shown in FIG. 8.

FIG. 9B is a schematic diagram showing another arrangement pattern of the backbone member shown in FIG. 8.

FIG. 9C is a schematic diagram showing yet another arrangement pattern of the backbone member shown in FIG. 8.

### EXEMPLARY EMBODIMENTS FOR CARRYING OUT THE INVENTION

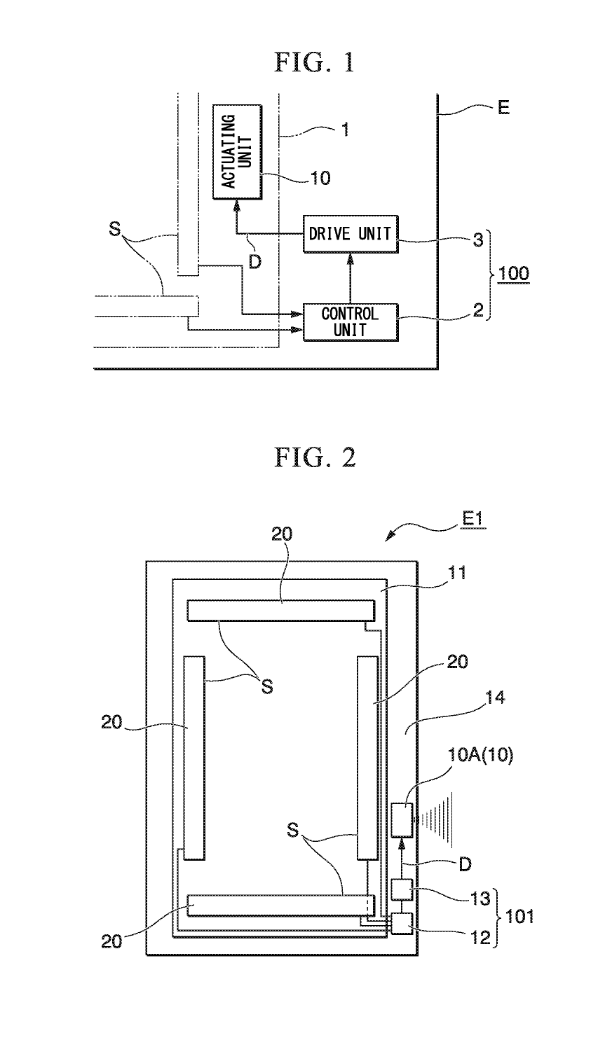

FIG. 1 is an outline block diagram showing the constitution of a deformation preventing device 100 for a display device E according to an exemplary embodiment of the present invention.

As shown in FIG. 1, the display device E includes a display unit 1 that serves as a display. The display unit 1 is sheet-like and elastically deformable.

In this sheet-shaped display unit 1 are provided a detection sensor S that detects the deformation amount of the display unit 1 (sheet) and the deformation preventing device 100.

The deformation preventing device 100 has a control unit 2 a drive unit 3. The control unit 2 compares the deformation amount of the display unit 1 detected by the detection sensor S with a prescribed value. The drive unit 3, on the basis of the comparison result from the control unit 2, outputs a drive signal D for causing a warning operation to be performed to an actuating unit 10 appended to the display unit 1.

As the actuating unit 10 are used various reporting devices that perform a warning on the basis of the drive signal D when the display unit 1 is bent by more than (equal to or greater than) the prescribed value. The control unit 2 may simply determine whether or not the deformation amount is greater than the prescribed value by comparing the deformation amount and the prescribed value, and may perform control on the basis of that determination result. The control unit 2 may also control the extent of the warning in accordance with the ratio or differential between the deformation amount and the prescribed value (adjustment of the amount of luminescence or volume adjustment of the warning sound).

According to the deformation preventing device 100 described above, in the case of the control unit 2 having determined that the deformation amount of the display unit 1 has become greater than the prescribed value, the drive unit 3 outputs to the actuating unit 10 provided in the display unit 1 the drive signal D for causing the warning operation to be performed.

On the basis of the drive signal D from the drive unit 3 described above, the actuating unit 10 can cause various warning operations to be performed by a warning LED, an audio output unit, a vibrator, and a separately used mobile terminal (smartphone) and central management device, in addition to a warning display in the display unit 1.

As a result, in the exemplary embodiment of the present invention, by causing the actuating unit 10 to actuate on the basis of the output of the drive signal D from the drive unit 3 to the actuating unit 10, even when the user is not viewing the display screen, he or she can recognize the fact that a bending stress is acting on the display unit 1. As a result, it is possible to reliably prevent breakage of the device.

### First Exemplary Embodiment

A deformation preventing device 101 for a display device E1 according to a first exemplary embodiment of the present invention will be described referring to FIG. 2 to FIG. 5C.

FIG. 2 shows the display device E1 including the deformation preventing device 101. The deformation preventing device 101 is a device that further embodies the deformation preventing device 100 shown in FIG. 1. The deformation preventing device 101 has a detection sensor S, an actuating unit 10 (10A to 10D), a display unit 11, a control unit 12, a drive unit 13, and an enclosure 14. The actuating unit 10 (10A to 10D) is provided in (appended to) the display unit 11. The display unit 11 displays images. The control unit 12 determines whether the deformation amount of the display unit 11 detected by the detection sensor S is greater than a prescribed value, and outputs a determination result indicating that the deformation amount of the display unit 11 is greater than the prescribed value. The drive unit 13, on the basis of the determination result from the control unit 12, outputs a drive signal D for causing a warning operation to be performed, to the actuating unit 10 (10A to 10D).

The display device E1 for the first exemplary embodiment is a display terminal that has a plate shape. The display device E1 may for example be a flexible display device that is used as electronic paper.

In the display device E1 according to the first exemplary embodiment, the display unit 11 is disposed in the center of the enclosure 14. The detection sensor S including a plurality of strain sensors 20 (four in the first exemplary embodiment) is provided in the display unit 11.

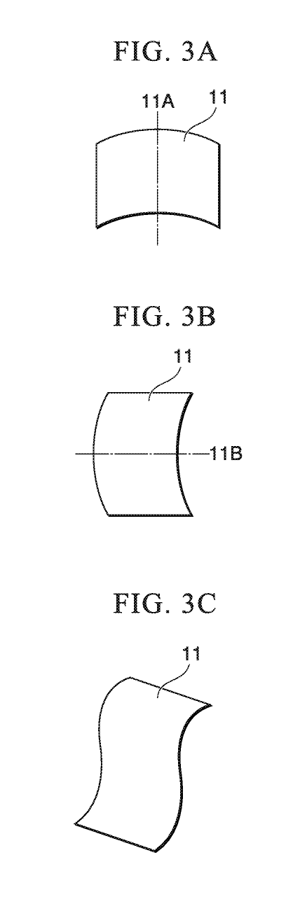

As shown in FIG. 2, these four strain sensors 20 are respectively disposed so as to follow the four edge portions of the display unit 11. When for example external forces that cause bending in the display unit 11 are applied as shown in FIGS. 3A to 3C whereby strain is generated in the display unit 11, the strain sensors 20 detect the amount of strain.

FIG. 3A shows the case of the left and right end portions of the display unit 11 being bent back centered on the vertical axis 11A. FIG. 3B shows the case of the top and bottom end portions of the display unit 11 being bent back centered on the horizontal axis 11B. FIG. 3C shows the case of the display unit 11 being bent back in a wave shape. Since the four strain sensors 20 are disposed so as to respectively follow the four edge portions of the display unit 11, the strain sensors 20 can measure the amount of strain in any of the cases shown in FIGS. 3A to 3C.

The actuating unit 10 performs a warning on the basis of the drive signal D when the display unit 1 is bent by an amount equal to or greater than the prescribed value. As shown in FIG. 2, in the first exemplary embodiment, an audio output unit 10A that generates a warning sound is provided as the actuating unit 10.

The arrangement of the strain sensors 20 is not limited to the arrangement shown in FIG. 2. The strain sensors 20 may further be arranged so as to follow the diagonal lines of the display unit 1. In this case, it is possible to more accurately recognize the flexural state of the display unit 11.

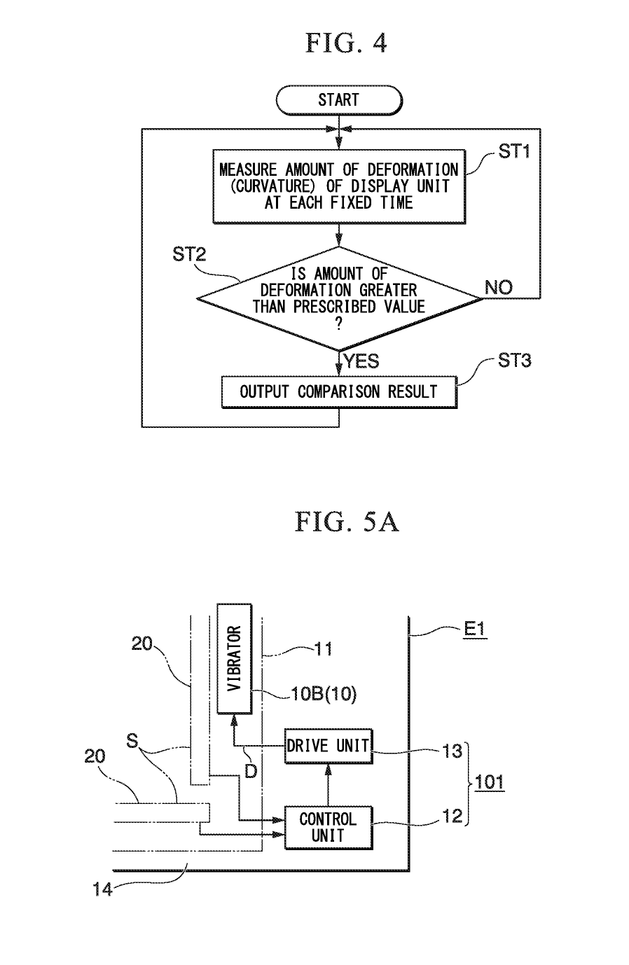

Next, the control content of the control unit 12 will be described referring to FIG. 4. The steps ST1 to ST4 shown in FIG. 4 are executed on the basis of the deformation prevention method or deformation prevention program of the display device E1.

### [Step ST1 (Detection Stage)]

The control unit 12 always performs fetching of a detection signal from the strain sensors 20 after the display unit 11 is powered on. First, the control unit 12, at each fixed time, measures the amount of deformation (curvature) of the display unit 11 (enclosure 14) on the basis of the detection signal of the strain sensor 20.

### [Step ST2 (Determination Stage)]

On the basis of the detection signal fetched in the detection stage of Step ST1, the control unit 12 determines whether or not the amount of deformation (curvature) of the display unit 11 is greater than a prescribed value. In the case of the control unit 12 having determined that the amount of deformation of the display unit 11 is greater than the prescribed value (“YES” in Step ST2), it proceeds to Step ST3. In the case of the control unit 12 having determined that the amount of deformation of the display unit 11 is equal to or less than the prescribed value (“NO” in Step ST2), it returns to Step 1. The control unit 12 performs the determination in Step ST2 for each detection signal of the four strain sensors 20. In the case of the control unit 12 having determined that the amount of deformation of the display unit 11 is greater than the prescribed value on the basis of at least one of the four detection signals, the process may proceed to Step ST3.

### [Step ST3 (Drive Signal Output Stage)]

In the case of the control unit 12 having determined that the amount of deformation (curvature) of the display unit 11 is greater than the prescribed value, it outputs the comparison result.

The drive unit 13, on the basis of the comparison result, outputs to the audio output unit 10A, which is the actuating unit 10, the drive signal D for causing the audio output unit 10A to perform a warning.

According to the deformation preventing device 101 for a display device of the first exemplary embodiment described above, in the case of the control unit 12 having determined that the amount of deformation of the display unit 11 is greater than the prescribed value, the drive unit 13 outputs the drive signal D for causing the actuating unit 10 provided in the display unit 11 to perform a warning.

On the basis of the drive signal D from the drive unit 13, the audio output unit 10A, which is the actuating unit 10, generates a warning sound. For this reason, in the first exemplary embodiment, even in the case of the user not viewing the display screen, it is possible for the user to recognize that a bending stress is acting on the device by means of this warning sound. As a result, it is possible to reliably prevent breakage of the device.

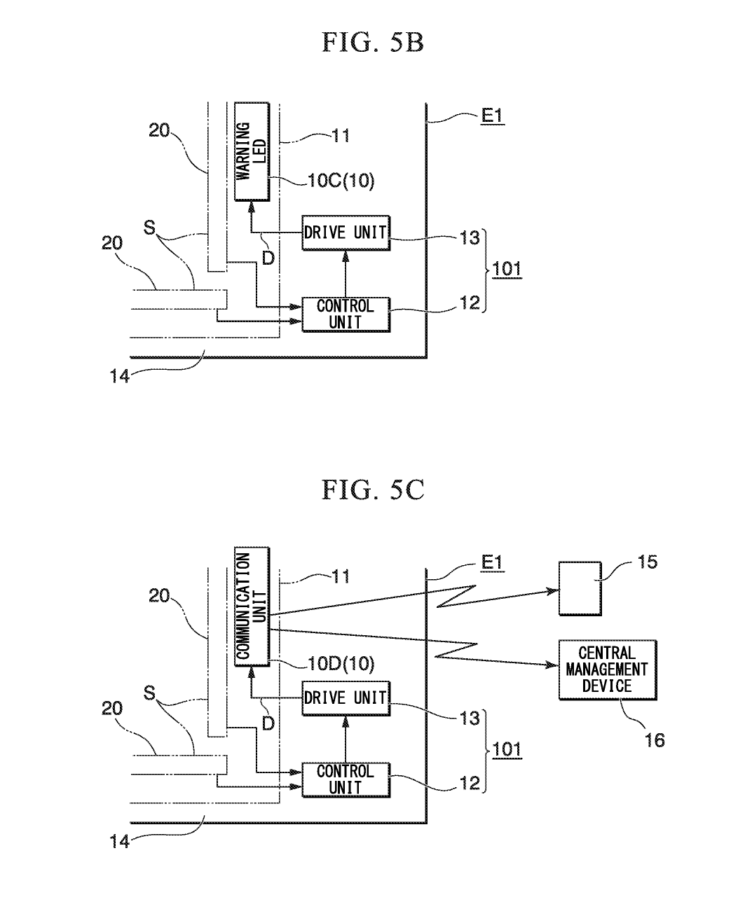

In the aforementioned, the audio output unit 10A that generates a warning sound is applied as the actuating unit 10. However, the actuating unit 10 is not limited to the audio output unit 10A. The actuating unit 10 may also be a vibrator (vibrating device) 10B that reports a warning by vibration as shown in FIG. 5A. The actuating unit 10 may also be a dedicated warning LED (light emitting diode) 10C that gives an optical warning as shown in FIG. 5B. The actuating unit 10 may also be a communication unit 10D that emits a warning to the outside by communication as shown in FIG. 5C. Use of these actuating units 10 is not limited to using any single one of these types of actuating units 10. Two or more types of these actuating units 10 may be selectively provided.

By performing communication with a portable terminal (smartphone) 15 that a user possesses or a management device 16 that intensively performs use management of devices, the communication unit 10 may convey to the outside that a bending stress is acting on the device.

In the first exemplary embodiment, at the same time as sending the drive signal D that drives the audio output unit 10A, the vibrator 10B, the warning LED 10C, and the communication unit 10D, the drive unit 13 may cause the display unit 11 to perform a warning display indicating that excessive bending is occurring.

### Second Exemplary Embodiment

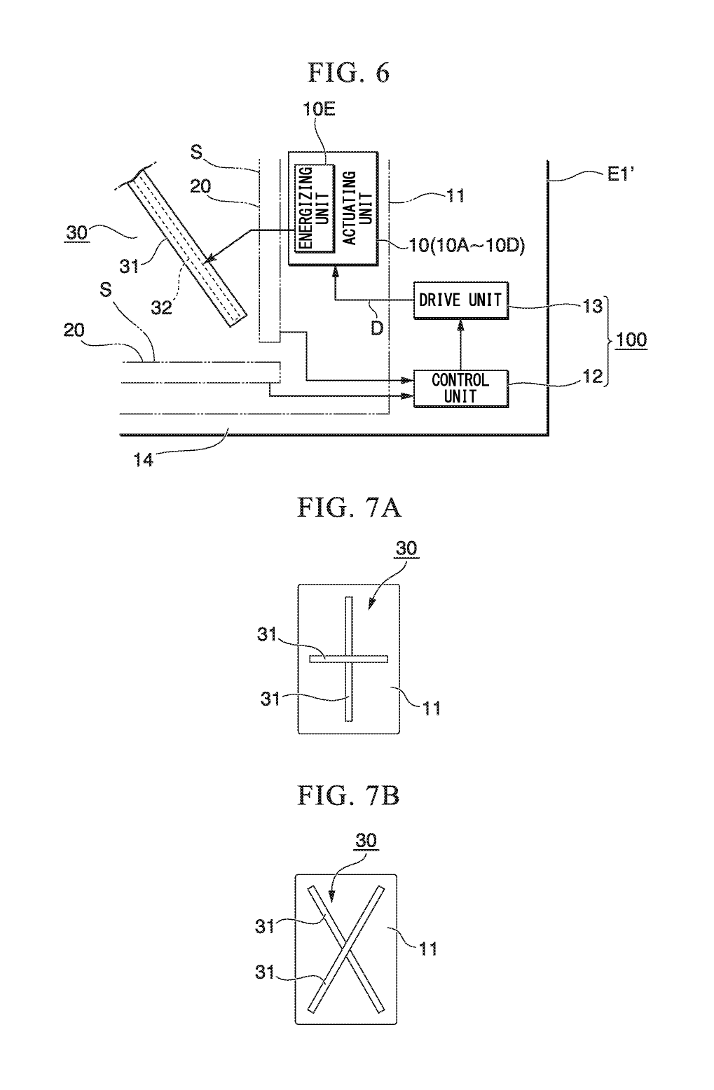

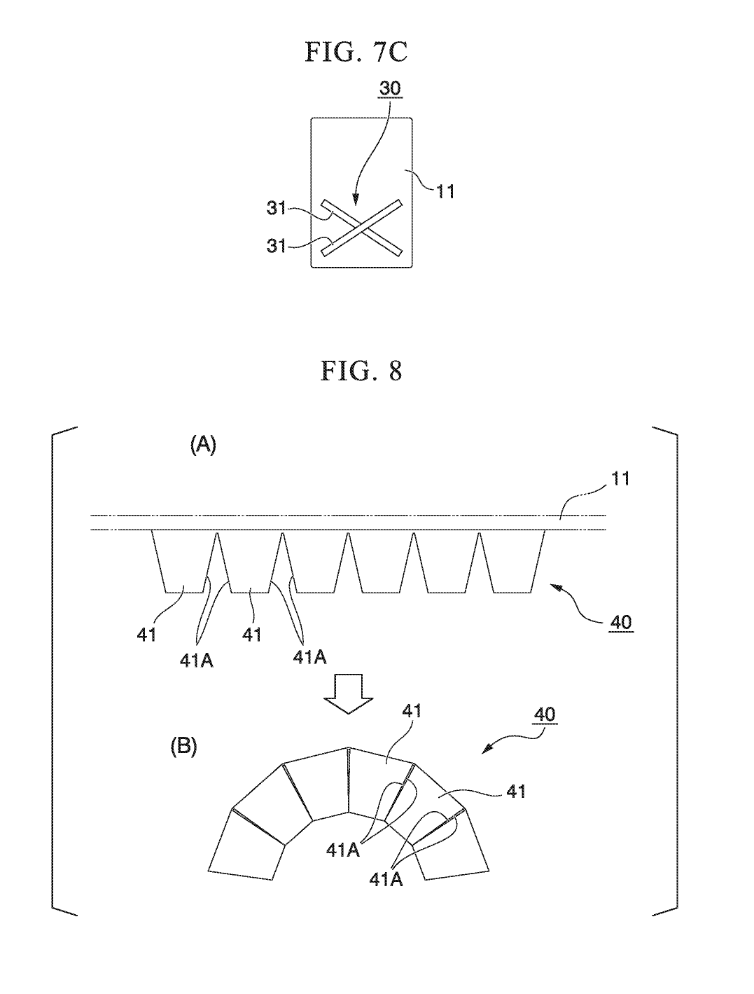

A device preventing device 101′ for a display device E1′ according to a second exemplary embodiment of the present invention will be described referring to FIG. 6 and FIG. 7A to FIG. 7C.

The deformation preventing device 101′ of the second exemplary embodiment differs from the deformation preventing device 101′ of the first exemplary embodiment on the point of a shape memory unit 30 being provided in the sheet-shaped display unit 11 as shown in FIGS. 7A to 7C, and an energizing unit 10E that actuates the shape memory unit 30 being provided as a portion of the actuating unit 10 as shown in FIG. 6. The other constitutions of the deformation preventing device 101′ are the same as those of the deformation preventing device 101.

The shape memory unit 30 has a heating unit 32 and a shape memory material 31. The heating unit 32 is for example a heater which emits heat by electricity fed from the energizing unit 10E. The shape memory material 31 is for example a shape memory alloy that reverts to a planar shape (or a linear shape) by the heat emitted by the heating unit 32.

As shown in FIG. 7A to FIG. 7C, two strips of the shape memory material 31 are arranged intersecting across the display unit 11. FIG. 7A shows an example of two strips of the shape memory material 31 being respectively arranged along the short side and long side of the display unit 11 and mutually intersecting at the center of the display unit 11. FIG. 7B shows an example of the two strips of the shape memory material 31 being respectively arranged along the diagonal lines of the display unit 11 and mutually intersecting at the center of the display unit 11. FIG. 7C shows an example of the two strips of the shape memory material 31 being arranged within a region of half of the display unit 11 and mutually intersecting. However, the arrangement patterns of the two strips of the shape memory material 31 are not limited to the examples shown in FIG. 7A to FIG. 7C.

In the case of the control unit 12 having determined that the amount of deformation of the sheet-shaped display unit 11 is greater than the prescribed value, the energizing unit 10E shown in FIG. 6, on the basis of the drive signal D from the drive unit 13, feeds electricity to the heating unit 32 built into the shape memory unit 30 (shape memory material 31) to heat the heating unit 32. Due to the heating of the heating unit 32, the shape memory material 31 becomes equal to or greater than a predetermined temperature, whereby the shape memory material 31 is restored to its original memorized planar shape (or linear shape). As a result, the display unit 11 is made to revert to the planar shape. In order to prevent the two strips of shape memory material 31 from overlapping each other, one of the two strips of shape memory material 31 may not be arranged at the intersection point.

The emerging unit 10E is provided as a portion of the actuating unit 10. The energizing unit 10E is provided in an additional manner with at least one of the audio output unit 10A, the vibrator 10B, the warning LED 10C, and the communication unit 10D.

According to the deformation preventing device 101′ for the display device E1′ of the second exemplary embodiment, when the control unit 12 has determined the amount of deformation of the display unit 11 to be greater than the prescribed value, the drive unit 13 outputs the drive signal D for causing the warning operation to the actuation unit 10 provided in the display unit 11.

In the second exemplary embodiment, on the basis of the drive signal D from the drive unit 13, the actuating unit 10 actuates the energizing portion 10E in addition to actuating at least one of the audio output unit 10A, the vibrator 10B, the warning LED 10C, and the communication unit 10D. Thereby, in the case of a bending stress having acted on the display device E1′, along with performing a warning, it is possible to cause the display unit 11 to revert to a planar shape by the shape memory unit 30.

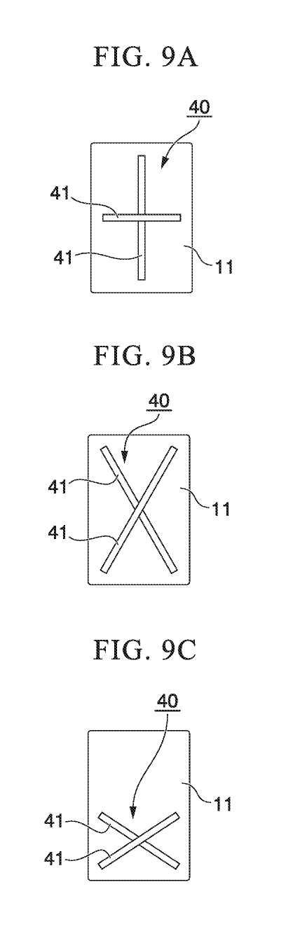

In the first exemplary embodiment and the second exemplary embodiment described above, the constitutions shown in FIGS. 8 to 9C may further be added.

Specifically, as shown in FIGS. 8 to 9C, a backbone member 40 that prevents the display unit 1 from bending by a specific angle or more is provided on the rear surface of the sheet-shaped display unit 11. The backbone member 40 has a plurality of projecting members 41 of the same shape. The plurality of projecting members 41 are aligned side by side. Adjacent projecting members 41 are mutually coupled. The adjacent projecting members 41 each have a side surface portion 41A that mutually makes contact. These side surface portions 41A have sloping surfaces in which the mutual interval therebetween gradually decreases while approaching the rear surface of the display unit 11. That is, the backbone member 40 is formed in a concave-convex shape as a whole. In other words, a V-shaped groove is formed between the mutually adjacent projecting members 41.

With this kind of constitution, in the case of a bend occurring in the backbone member 40 along with the display unit 11, as shown in the portion (A) of FIG. 8 and the portion (B) of FIG. 8, the side surface portions 41A of the mutually adjacent projecting members 41 make contact, thereby restricting further bending of the backbone member 40. Thereby, bending of the sheet-shaped display unit 11 by a certain bending degree or more is prevented.

Two backbone members 40 are arranged intersecting across the display unit 11. FIG. 9A shows an example of two backbone members 40 being respectively arranged along the short side and long side of the display unit 11 and mutually intersecting at the center of the display unit 11. FIG. 9B shows an example of the two backbone members 40 being respectively arranged along the diagonal lines of the display unit 11 and mutually intersecting at the center of the display unit 11. FIG. 9C shows an example of two backbone members 40 being arranged within a region of half of the display unit 11 and mutually intersecting. In order to prevent mutual overlap of two backbone members 40, one of the two backbone members 40 may not be arranged at the intersection point. However, the arrangement patterns of the two backbone members 4 are not limited to the examples shown in FIGS. 9A to 9C.

Each of the deformation preventing devices 100, 101, 101′ may internally have a computer system. The process of operation may be stored in a computer-readable recording medium in the form of a program, and by a computer system reading this program and executing it, the aforementioned processes may be performed. A “computer system” here includes a CPU, various types of memory, an OS and hardware such as peripheral devices.

Also, the “computer system” in the case of utilizing a WWW system also includes a homepage providing environment (or display environment).

By recording a program for realizing each step on a computer-readable recording medium, or by recording a program for realizing this function in computer-readable recording medium, a process may be performed that causes the program that is stored in this recording medium to be read into a computer system and executed.

The “computer-readable recording medium” includes writable non-volatile memory such as a flexible desk, a magneto-optical disk, ROM and flash memory, portable media such as a CD-ROM, and a storage device such as a hard disk that is housed in a computer system.

The “computer-readable recording medium” also includes one that retains the program for a given period of time, such as volatile memory (for example DRAM (Dynamic Random Access Memory)) in a computer system that functions as a server or client in the case of the program being transmitted via a network such as the Internet or a communication line such as a telephone line.

The aforementioned program may be transmitted from a computer system having this program stored in a storage device thereof to another computer system via a transmission media or by transmission waves in the transmission media. The term “transmission media” that transmits the program includes a media having a function for transferring information, such as a network (communication network) such as the Internet, or a communication line (communication cable) such as a telephone line.

Moreover, the aforementioned program may be for realizing a part of the aforementioned functions.

Furthermore, the aforementioned may be a so-called differential file (differential program), whereby the functions described above can be realized by a combination with programs that are already recorded in the computer system.

The present invention has been described above referring to the exemplary embodiments, but the present invention is not limited to aforementioned exemplary embodiments. Various changes that could be understood by a person skilled in the art can be made to the structures and details of the present invention within the scope of the present invention.

This application is based upon and claims the benefit of priority from Japanese patent application No. 2014-191433, filed on Sep. 19, 2014, the disclosure of which is incorporated herein in its entirety by reference.

### INDUSTRIAL APPLICABILITY

The present invention relates to a deformation preventing device that can give a warning when a force acts that attempts to bend a sheet-shaped display device, and to a deformation prevention method, and a deformation prevention program.

### REFERENCE SYMBOLS

1: Display unit
2: Control unit
3: Drive unit
10: Actuating unit
10A: Audio output unit
10B: Vibrator
10C: Warning LED
10D: Energizing unit
10E: Communication unit
11: Display unit
12: Control unit
13: Drive unit
20: Strain sensor
30: Shape memory unit
40: Backbone member
100: Deformation preventing device
101: Deformation preventing device
101′: Deformation preventing device
E: Display device
E1: Display device
E1′: Display device
D: Drive signal
S: Detection sensor

1. A deformation preventing device for a display device, the deformation preventing device comprising:
an elastically deformable sheet-shaped display unit;
a sensor that integrally deforms with the display unit, and outputs a signal corresponding to deformation of the display unit;
a control unit that compares an amount of the deformation of the display unit with a prescribed value based on the signal, and outputs a comparison result; and
a drive unit that outputs a drive signal to an actuating unit based on the comparison result, the drive signal causing the actuating unit to perform a warning operation, the actuating unit being different from the display unit.

2. The deformation preventing device for a display device according to claim 1, wherein the actuating unit performs the warning operation based on the drive signal in a case of the display unit being by bent more than the prescribed value.

3. The deformation preventing device for a display device according to claim 1, wherein the actuating unit includes an audio output unit that reports by sound that the amount of the deformation of the display unit is greater than the prescribed value.

4. The deformation preventing device for a display device according to claim 1, wherein the actuating unit includes a vibrator that reports by vibration that the amount of the deformation of the display unit is greater than the prescribed value.

5. The deformation preventing device for a display device according to claim 1, wherein the actuating unit includes a warning unit that optically reports that the amount of the deformation of the display unit is greater than the prescribed value.

6. The deformation preventing device for a display device according to claim 5, wherein the warning unit includes a light emitting diode.

7. The deformation preventing device for a display device according to claim 1, wherein the actuating unit includes a communication unit that reports to an outside by communication that the amount of the deformation of the display unit is greater than the prescribed value.

8. The deformation preventing device for a display device according to claim 1, wherein the sensor is a strain sensor that is disposed so as to follow an edge portion of the display unit.

9. The deformation preventing device for a display device according to claim 1, further comprising:
a shape memory unit provided in the display unit,
wherein the shape memory unit includes a shape memory material that reverts to a planar shape or a linear shape by a temperature rise, and a heating unit that heats the shape memory material; and
the actuating unit includes an energizing unit that causes the display unit to revert to a planar shape by supplying electrical current to the heating unit in a case of the amount of the deformation of the display unit being greater than the prescribed value.

10. The deformation preventing device for a display device according to claim 1, further comprising:
a backbone member having a concave-convex shape, the backbone member being provided in the display unit and preventing the display unit from bending by a specific angle or more.

11. A deformation prevention method for a display device, the method comprising:
outputting, by a sensor that integrally deforms with an elastically deformable sheet-shaped display unit, a signal corresponding to deformation of the display unit;
comparing an amount of the deformation of the display unit with a prescribed value of the display unit based on the basis of the signal, and outputting a comparison result; and
outputting a drive signal to an actuating unit based on the comparison result, the drive signal causing the actuating unit to perform a warning operation, the actuating unit being different from the display unit.

12. A non-transitory computer-readable recording medium storing a deformation prevention program for a display device, the program causing the display device to execute:
outputting, by a sensor that integrally deforms with an elastically deformable sheet-shaped display unit, a signal corresponding to deformation of the display unit;
comparing an amount of the deformation of the display unit with a prescribed value of the display unit based on the basis of the signal, and outputting a comparison result; and
outputting a drive signal to an actuating unit based on the comparison result, the drive signal causing the actuating unit to perform a warning operation, the actuating unit being different from the display unit.
